(19) United States
(12) Patent Application Publication
(10) Pub. No.: US 2005/0113152 A1
(43) Pub. Date: May 26, 2005

(54) Method and apparatus for controlling power-off operation of mobile terminal

(75) Inventor: Hak-Hwan Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/978,443

(22) Filed: Nov. 2, 2004

(30) Foreign Application Priority Data
Nov. 26, 2003 (KR) 2003-84584

(51) Int. Cl. H04B 1/38

(52) U.S. Cl. 455/574

(57) ABSTRACT

Disclosed herein are a method and an apparatus for controlling a power-off operation of a mobile terminal. The mobile terminal is set to a first power-off mode and a battery value thereof is then checked. The mobile terminal is powered off if the battery value is equal to a first power-off value. Thereafter, when the mobile terminal is powered on, a desired operation is performed for a period of time corresponding to a difference between the first power-off value and a second power-off value.

### PRIORITY

This application claims the benefit under 35 U.S.C. §119(a) of an application entitled “METHOD FOR CONTROLLING POWER-OFF OPERATION OF MOBILE TERMINAL”, filed in the Korean Intellectual Property Office on Nov. 26, 2003 and assigned Serial No. 2003-84584, the contents of which are hereby incorporated by reference.

### BACKGROUND OF THE INVENTION

1. Field of the Invention

The present invention relates to a method and apparatus for controlling a power-off operation of a mobile terminal. More particularly, the present invention relates to a method and apparatus for enabling a mobile terminal to be used for a certain period of time when it is temporarily powered on after being automatically powered off due to a low battery voltage.

2. Description of the Related Art

In general, a mobile terminal has a basic power-off value set therein so that it can be powered off when the battery voltage thereof reaches the basic power-off value. However, because of such a low voltage of the mobile terminal, it is nearly impossible to use the mobile terminal when it is temporarily powered on after being automatically powered off due to low battery voltage as mentioned above. For this reason, a user can rarely use such a powered-off mobile terminal even when he/she wants to make or receive a phone call or search a phone book for a desired phone number due to urgent business.

### SUMMARY OF THE INVENTION

Therefore, the present invention has been made in view of the above problem, and it is an object of the present invention to provide a method for enabling a mobile terminal to be used for a certain period of time when it is temporarily powered on after being automatically powered off at a predetermined battery voltage.

In accordance with an aspect of the present invention, the above and other objects can be accomplished by the provision of a method for controlling a power-off operation of a mobile terminal, comprising: a) setting the mobile terminal to a first power-off mode and then checking a battery value of the mobile terminal; b) powering off the mobile terminal if the battery value is equal to a first power-off value; and c) performing a desired operation for a period of time corresponding to a difference between the first power-off value and a second power-off value when the mobile terminal is powered on.

In accordance with another aspect of the present invention, there is provided a method for controlling a power-off operation of a mobile terminal, comprising: a) determining a current power-off mode of the mobile terminal; b) powering off the mobile terminal if a battery value of the mobile terminal is equal to a first power-off value when the current power-off mode is determined to be a first power-off mode; c) powering off the mobile terminal if the battery value of the terminal is equal to a second power-off value when the current power-off mode is determined to be a second power-off mode; d) determining the current power-off mode of the mobile terminal when the terminal is powered on; e) performing a desired operation for a period of time corresponding to a difference between the first power-off value and the second power-off value when the current power-off mode is determined to be the first power-off mode; f) powering off the mobile terminal when the battery value of the terminal reaches the second power-off value; and g) powering off the mobile terminal after the lapse of a predetermined time when the current power-off mode is determined to be the second power-off mode.

In accordance with yet another aspect of the present invention, there is provided a method for controlling a power-off operation of a mobile terminal, comprising: a) setting a usage time of the mobile terminal when a power-off control menu is selected; b) converting the set usage time into an analog-to-digital converted (ADC) value of a corresponding battery voltage; c) setting the converted ADC value as a first power-off value and then setting the mobile terminal to a first power-off mode having the set first power-off value; d) checking a battery value of the mobile terminal in the first power-off mode; e) powering off the mobile terminal if the battery value is equal to the first power-off value; and f) performing a desired operation for a period of time corresponding to a difference between the first power-off value and a second power-off value when the mobile terminal is powered on.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a mobile terminal according to an embodiment of the present invention;

FIG. 2 is a flow chart illustrating a process of setting a power-off mode of the mobile terminal according to an embodiment of the present invention; and

FIG. 3 is a flow chart illustrating a process of controlling a power-off operation of the mobile terminal according to an embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

In an embodiment of the present invention, a first power-off mode of a mobile terminal refers to a state where the mobile terminal can be used for a period of time corresponding to a difference between a first power-off value, which is a specific battery value, and a second power-off value, which is a basic battery power value as defined below, when it is temporarily powered on after being automatically powered off at the first power-off value. A second power-off mode of the mobile terminal refers to a state where the mobile terminal cannot be used due to a low battery value, namely, the second power-off value, when it is temporarily powered on after being automatically powered off at the second power-off value. The basic battery value is a low battery value for disabling the normal operation of the mobile terminal and automatically powering it off.

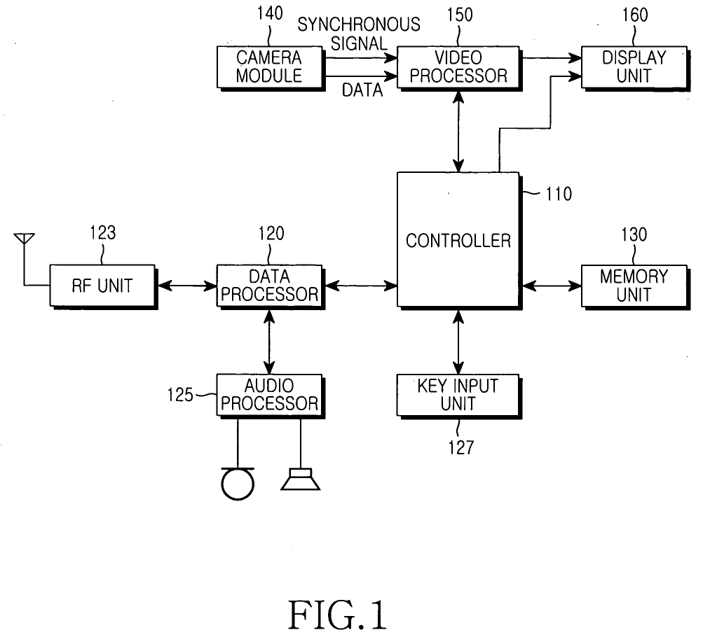

FIG. 1 is a block diagram showing the configuration of a camera-equipped mobile terminal according to an embodiment of the present invention.

Referring to FIG. 1, a radio frequency (RF) unit 123 acts to perform a wireless communication function of the mobile terminal. To this end, the RF unit 123 comprises an RF transmitter for up-converting the frequency of a signal to be transmitted and amplifying the resulting signal, and an RF receiver for low-noise amplifying a received signal and down-converting the frequency of the resulting signal. A data processor 120 comprises a transmitter for encoding and modulating the signal to be transmitted, and a receiver for demodulating and decoding the received signal. That is, the data processor 120 is implemented with a modem and a codec. The codec comprises a data codec for processing packet data, and an audio codec for processing an audio signal. An audio processor 125 reproduces a receive audio signal from the audio codec of the data processor 120, or transfers a transmit audio signal from a microphone to the audio codec.

A memory unit 130 preferably comprises a program memory and a data memory. The program memory acts to stores programs for controlling a general operation of the mobile terminal and for controlling of a process of enabling the mobile terminal to be used for a period of time based on a specific battery value when it is temporarily powered on after being automatically powered off at the specific battery value, according to an embodiment of the present invention. The data memory temporarily stores data generated during execution of the above programs. The memory unit 130 also stores a conversion table comnprising analog-to-digital converted (ADC) values corresponding, respectively, to various times according to an embodiment of the present invention. The conversion table is created by measuring correlations between usage times of the mobile terminal and ADC values of battery voltages. In an embodiment of the present invention, the conversion table has ADC values corresponding to talk and standby times.

A controller 110 controls the overall operation of the mobile terminal. The controller 110 may include the data processor 120. In an embodiment of the present invention, the controller 110 powers off the mobile terminal if the battery value of the mobile terminal reaches a first power-off value when the mobile terminal is in a first power-off mode. Thereafter, when the powered-off mobile terminal is temporarily powered on, the controller 110 performs a desired operation of the mobile terminal for a period of time corresponding to a difference between the first power-off value and a second power-off value. The controller 110 also powers off the mobile terminal if the battery value of the mobile terminal reaches the second power-off value when the terminal is in a second power-off mode.

A camera module 140 includes a camera sensor for capturing an image and converting an optical signal of the captured image into an electrical signal, and a signal processor for converting an analog image signal from the camera sensor into digital data. The camera sensor may be, for example, a charge-coupled device (CCD) sensor and the signal processor may be, for example, a digital signal processor (DSP). The camera sensor and the signal processor may be formed integrally with each other or separately from each other.

A video processor 150 functions to generate frame data to display a video signal from the camera module 140. That is, the video processor 150 processes the video signal from the camera module 140 on a frame-by-frame basis to output frame data suitably to the characteristics and size of a display unit 160. The video processor 150 includes a video codec for compressing frame data to be displayed through the display unit 160, in a predetermined manner, or restoring compressed frame data to original frame data. The video codec may be, for example, a JPEG codec, MPEG4 codec, Wavelet codec, or and so on. The video processor 150 may have an on-screen display (OSD) function of outputting OSD data of a picture displayed on the display unit 160 under the control of the controller 110.

The display unit 160 functions to display a video signal from the video processor 150 and user data from the controller 110 on the screen thereof. The display unit 160 may employ a liquid crystal display (LCD). In this case, the display unit 160 may include an LCD controller and a memory for storage of video data, in addition to the LCD. The LCD may serve as an input unit when it is implemented in a touch screen manner. In an embodiment of the present invention, the display unit 160 displays a message indicative of the fact that the mobile terminal has been powered off in the first power-off mode and a period of time for which the mobile terminal is usable upon being temporarily powered on. The display unit 160 also displays a message indicative of the usable time of the mobile terminal when the terminal is temporarily powered on. A key input unit 127 has keys for inputting numeric and character information, and function keys for setting various functions.

The operation of the mobile terminal with the above-stated configuration will hereinafter be described in detail with reference to FIG. 1. In an outgoing call mode, when a user, through the key input unit 127, dials and then sets a send mode, the controller 110 processes received dialed information through the data processor 120, converts the processed information into an RF signal through the RF unit 123 and transmits the converted RF signal through an antenna. Thereafter, upon generation of a response signal by a called party, the controller 110 recognizes the response signal generation through the RF unit 123 and data processor 120. The controller 110 then establishes a voice call path through the audio processor 125, so that the user can communicate with the called party. In an incoming call mode, the controller 110 recognizes reception of an incoming call through the data processor 120 and generates a ring signal through the audio processor 125. Thereafter, if the user responds to the incoming call, the controller 110 establishes a voice call path through the audio processor 125 to perform the communication function. Although the voice communication function has been described as an example to be performed in the outgoing and incoming call modes, a data communication function may also be performed in the same modes to transmit and receive packet data and video data. In a standby mode or text communication mode, the controller 110 processes text data through the data processor 120 and displays the processed text data on the display unit 160.

A description will hereinafter be given of a process of controlling a power-off operation of the mobile terminal. When the mobile terminal is in the first power-off mode, the controller 110 determines whether the battery value of the mobile terminal has reached the first power-off value. Upon determining that the battery value of the mobile terminal has reached the first power-off value, the controller 110 powers off the mobile terminal. Thereafter, when the mobile terminal is temporarily powered on, the controller 110 performs a control operation to enable the user to use the mobile terminal for the time period corresponding to the difference between the first power-off value and the second power-off value. Thereafter, when the mobile terminal is in the second power-off mode, the controller 110 determines whether the battery value of the mobile terminal has reached the second power-off value. If the battery value of the mobile terminal is determined to have reached the second power-off value, the controller 110 powers off the mobile terminal. Thereafter, when the mobile terminal is temporarily powered on, the controller 110 powers off the mobile terminal again after the lapse of a predetermined time.

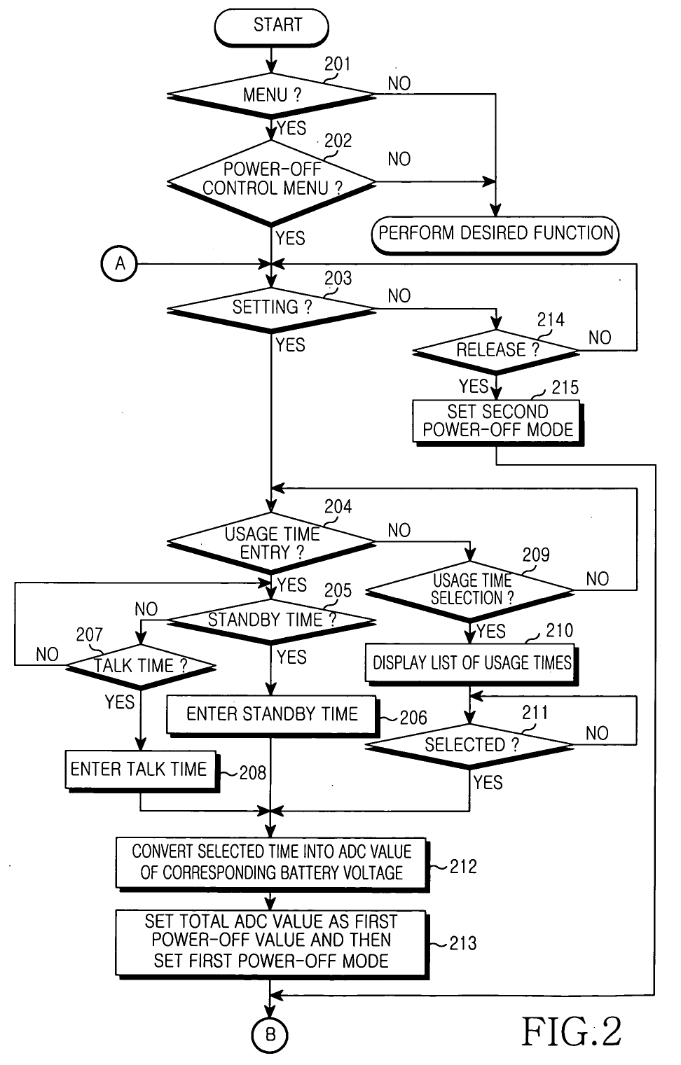

FIG. 2 is a flow chart illustrating a process of setting the first power-off mode of the mobile terminal according to an embodiment of the present invention.

The first power-off mode setting process will hereinafter be described in detail with reference to FIGS. 1 and 2.

Referring to FIG. 2, when the user selects a menu through the key input unit 127, the controller 110 recognizes the menu selection at step 201 and displays items of the menu on the display unit 160. If the user selects a power-off control menu from among the displayed menu items at step 202, the controller 110 displays, on the display unit 160, a message asking the user whether to set the first power-off mode. If the user selects the setting of the first power-off mode at step 203, the controller 110 sets the first power-off mode in the following manner. That is, the controller 110 determines at step 204 whether the user has selected a usage time entry menu. Upon determining at step 204 that the user has selected the usage time entry menu, the controller 110 displays sub-menus of the usage time entry menu. If the user selects a standby time menu from among the displayed sub-menus at step 205, the controller 110 displays a new window for standby time entry on the display unit 160. If the user enters a standby time at step 206, the controller 110 proceeds to step 212 to convert the entered time into an ADC value of a corresponding battery voltage. At step 212, the controller 110 extracts the ADC value corresponding to the entered time from the conversion table stored in the memory unit 130. At this time, owing to the entry of the standby time, a talk time is automatically set on the basis of a corresponding ADC value included in the conversion table. Alternatively, where the user selects a talk time menu from among the displayed sub-menus of the usage time entry menu at step 207, the controller 110 displays a new window for talk time entry on the display unit 160. If the user enters a talk time at step 208, the controller 110 proceeds to step 212 to convert the entered time into an ADC value of a corresponding battery voltage. At step 212, the controller 110 extracts the ADC value corresponding to the entered time from the conversion table in the memory unit 130. At this time, owing to the entry of the talk time, a standby time is automatically set on the basis of a corresponding ADC value included in the conversion table.

On the other hand, when the user selects a usage time selection menu subsequently to the selection of the setting of the first power-off mode at step 209, the controller 110 displays a list of usage times on the display unit 160 at step 210. If the user selects a desired usage time from the displayed usage time list at step 211, the controller 110 proceeds to step 212 to convert the selected time into an ADC value of a corresponding battery voltage. At this time, the selected time is a standby time or talk time. Although the usage time list has been described in the present embodiment to include the standby time and talk time as an example, it may include any other times as needed. At step 213, the controller 110 sets the total ADC value converted at the above step 212 as the first power-off value and then sets the first power-off mode having the set first power-off value.

On the other hand, when the user selects release of the first power-off mode in the power-off control menu at step 214, the controller 110 proceeds to step 215 to set the second power-off mode having the basic battery value as the second power-off value.

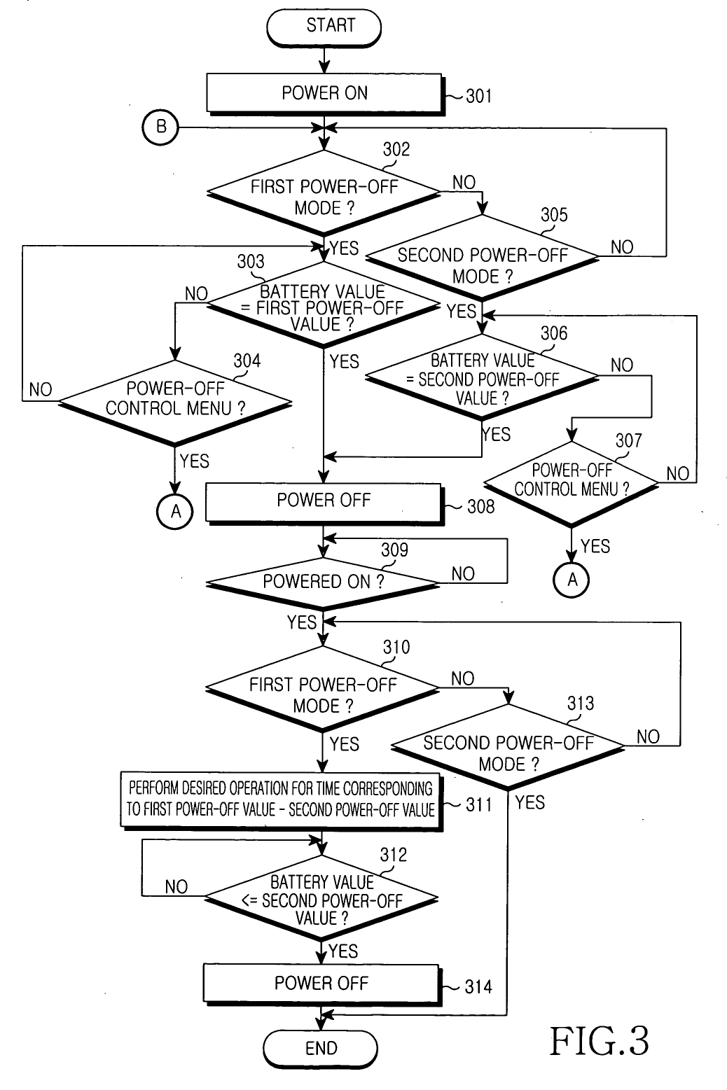

FIG. 3 is a flow chart illustrating the process of controlling the power-off operation of the mobile terminal according to an embodiment of the present invention.

The power-off control process will hereinafter be described in detail with reference to FIGS. 1 to 3.

Referring to FIG. 3, the controller 110 determines at step 302 whether the mobile terminal is in the first power-off mode under the condition of being powered on at step 301. Upon determining at step 302 that the mobile terminal is in the first power-off mode, the controller 110 determines at step 303 whether the battery value of the mobile terminal has reached the first power-off value. Here, the battery value of the mobile terminal is an ADC value of a corresponding battery voltage. If the battery value of the mobile terminal is determined not to have reached the first power-off value at step 303, the controller 110 determines at step 304 whether the user has selected the power-off control menu. Upon determining at step 304 that the user has selected the power-off control menu, the controller 110 changes the first power-off value of the first power-off mode or releases the first power-off mode through steps 203 to 215 of FIG. 2. However, if the battery value of the mobile terminal is determined to have reached the first power-off value at step 303, the controller 110 powers off the mobile terminal at step 308. In this case, before powering off the mobile terminal, the controller 110 displays, on the display unit 160, a message indicative of the fact that the mobile terminal is in the first power-off mode and a period of time for which the mobile terminal is usable upon being temporarily powered on. Thereafter, the controller 110 determines at step 309 whether the mobile terminal has been temporarily powered on by the user. Upon determining at step 309 that the mobile terminal has been temporarily powered on by the user, the controller 110 determines at step 310 whether the mobile terminal is in the first power-off mode. At this time, the controller 110 displays the remaining battery voltage level of the mobile terminal and a usage time of the mobile terminal corresponding thereto on the display unit 160. If the mobile terminal is determined to be in the first power-off mode at step 310, the controller 110 proceeds to step 311. At step 311, the controller 110 obtains the usage time (standby time and talk time) corresponding to the difference between the ADC value of the first power-off value and the ADC value of the second power-off value on the basis of the conversion table stored in the memory unit 130 and allows the user to perform a desired operation through the mobile terminal for the obtained usage time. If the battery value of the mobile terminal is determined to have reached the second power-off value, which is the basic battery value of the mobile terminal, at step 312 while the desired operation is performed, the controller 110 proceeds to step 314 to power off the mobile terminal.

Meanwhile, in the case of determining at step 305 that the mobile terminal is in the second power-off mode under the condition of being powered on at step 301, the controller 110 determines at step 306 whether the battery value of the mobile terminal has reached the second power-off value. If the battery value of the mobile terminal is determined not to have reached the second power-off value at step 306, the controller 110 determines at step 307 whether the user has selected the power-off control menu. Upon determining at step 307 that the user has selected the power-off control menu, the controller 110 sets the second power-off mode through steps 203 to 215 of FIG. 2. However, if the battery value of the mobile terminal is determined to have reached the second power-off value at step 306, the controller 110 powers off the mobile terminal at step 308. Thereafter, the controller 110 determines at step 309 whether the mobile terminal has been temporarily powered on by the user. In the case of determining at step 309 that the mobile terminal has been temporarily powered on, the controller 110 determines at step 313 whether the mobile terminal is in the second power-off mode. If the mobile terminal is determined to be in the second power-off mode at step 313, the controller 110 powers off the terminal again after the lapse of a predetermined time at step 314. At step 314, it is no longer possible to operate the mobile terminal until its battery is recharged.

As apparent from the above description, according to the present invention, the mobile terminal is powered off at a predetermined battery voltage, so that it can be temporarily powered on and used by the user in the case of emergency. Further, the mobile terminal can be handily utilized when the user forgets to turn off the mobile terminal while staying for a long time in a location where mobile terminal charging is not possible.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for controlling a power-off operation of a mobile terminal, comprising the steps of:
a) setting the mobile terminal to a first power-off mode and then checking a battery value of the mobile terminal;
b) powering off the mobile terminal if the battery value is equal to a first power-off value; and
c) performing a desired operation for a period of time corresponding to a difference between the first power-off value and a second power-off value when the mobile terminal is powered on.

2. The method as set forth in claim 1, wherein the first power-off value is an analog to digital converted (ADC) value of a battery voltage corresponding to a predetermined time.

3. The method as set forth in claim 1, wherein the battery value of the mobile terminal is an ADC value of a corresponding battery voltage.

4. The method as set forth in claim 1, further comprising:
d) determining the battery value of the mobile terminal when the first power-off mode is released;
e) powering off the mobile terminal if the battery value is equal to the second power-off value; and
f) powering off the mobile terminal after the lapse of a predetermined time when the terminal is powered on.

5. The method as set forth in claim 1, wherein the first power-off value is greater than or equal to the second power-off value.

6. The method as set forth in claim 1, wherein the setting of the mobile terminal to the first power-off mode includes:
setting a usage time of the mobile terminal when a power-off control menu is selected;
converting the set usage time into an ADC value of a corresponding battery voltage; and
setting the converted ADC value as the first power-off value and then setting the mobile terminal to the first power-off mode having the set first power-off value.

7. A method for controlling a power-off operation of a mobile terminal, comprising:
a) determining a current power-off mode of the mobile terminal;
b) powering off the mobile terminal if a battery value of the terminal is equal to a first power-off value when the current power-off mode is determined to be a first power-off mode;
c) powering off the mobile terminal if the battery value of the terminal is equal to a second power-off value when the current power-off mode is determined to be a second power-off mode;
d) determining the current power-off mode of the mobile terminal when the terminal is powered on;
e) performing a desired operation for a period of time corresponding to a difference between the first power-off value and the second power-off value when the current power-off mode is determined to be the first power-off mode;
f) powering off the mobile terminal when the battery value of the terminal reaches the second power-off value; and
g) powering off the mobile terminal after the lapse of a predetermined time when the current power-off mode is determined to be the second power-off mode.

8. A method for controlling a power-off operation of a mobile terminal, comprising:
a) setting a usage time of the mobile terminal when a power-off control menu is selected;
b) converting the set usage time into an ADC value of a corresponding battery voltage;
c) setting the converted ADC value as a first power-off value and then setting the mobile terminal to a first power-off mode having the set first power-off value;
d) determining a battery value of the mobile terminal in the first power-off mode;
e) powering off the mobile terminal if the battery value is equal to the first power-off value; and
f) performing a desired operation for a period of time corresponding to a difference between the first power-off value and a second power-off value when the mobile terminal is powered on.

9. A mobile terminal apparatus with a controlled power-off operation, comprising:
a key input unit for entering data into the apparatus;
a memory unit for storing input data and reference data;
a battery;
a display unit; and
a controller for determining whether the battery value of the mobile terminal has reached a first power-off value, and a second power-off value.

10. The mobile terminal of claim 9, wherein, when the controller determines that the battery value of the mobile terminal has reached the first power-off value, the controller powers off the mobile terminal.

11. The mobile terminal of claim 10, wherein, when the mobile terminal is temporarily powered on, the controller enables the user to use the mobile terminal for the time period corresponding to the difference between the first power-off value and the second power-off value.

12. The mobile terminal of claim 11, wherein, when the mobile terminal is in the second power-off mode, the controller determines whether the battery value of the mobile terminal has reached the second power-off value;
wherein further, if the battery value of the mobile terminal is determined to have reached the second power-off value, the controller powers off the mobile terminal again after the lapse of a predetermined time.
